(19) United States
(12) Patent Application Publication
(10) Pub. No.: US 2004/0081311 A1
(43) Pub. Date: Apr. 29, 2004

(54) Method abandoned call rescue

(76) Inventor: Paul Thompson, Bryanston (ZA)

Correspondence Address: Welsh & Katz, Ltd., Jon P. Christensen, 22nd Floor, 120 South Riverside Plaza, Chicago, IL, 60606, US

(21) Appl. No.: 10/278,368

(22) Filed: Oct. 23, 2002

(51) Int. Cl. H04M 3/00; H04M 5/00; H04M 3/42

(52) U.S. Cl. 379/266.07; 379/210.01

(57) ABSTRACT

A method and apparatus are provided for establishing contact with clients in a call center having a plurality of agents. The method includes the steps of collecting call associated information from a plurality of abandoned calls from clients, comparing the collected call associated information with a callback criteria and calling back those clients whose call associated information meets or exceeds the callback criteria.

### FIELD OF THE INVENTION

The field of the invention relates to communication systems and more particularly to automatic call distributors.

### BACKGROUND OF THE INVENTION

Call-centers are generally known. A call-center is typically used wherever a large number of calls must be handled for some common enterprise. Typically, the calls of the enterprise are routed through the call-center as a means of processing the calls under a common format.

Call-centers typically include at least three elements: an automatic call distributor (ACD), a group of agents for handling the calls, and a host computer containing customer information. The individual agents of the groups of agents are each typically provided with a telephone console and a computer terminal. The telephone terminal may be used to receive customer calls distributed to the agent by the ACD. The terminal may be used to retrieve customer records from the host.

Call-centers are typically automated in the delivery of calls to agents and in the retrieval of customer records for use by agents. Features within the PSTN such as dialed number identification service (DNIS) and automatic number identification (ANI) may be used to determine not only the destination of the call, but also the identity of the caller. DNIS and ANI information, in fact, may be delivered by the PSTN to the ACD in advance of call delivery.

Based upon the destination of the call and identity of the caller, the ACD may select the agent most qualified to service the call. By sending an identifier of the selected agent along with the identity of the caller to the host, the host may automatically retrieve and download customer records to the agent's terminal at the same instant as the call arrives.

While call centers work well, their ability to service calls is dependent upon the number of agents scheduled to work during any particular time period. During time periods when more calls arrive then there are agents to handle calls, incoming calls are often placed in call queues to await availability of an agent. If the overload continues, callers may remain in the queues for long periods and may hang up in frustration. Because of the importance of serving customers and clients on a timely basis, a need exists for a method of avoiding the economic loss associated with abandoned calls.

### SUMMARY

A method and apparatus are provided for establishing contact with clients in a call center having a plurality of agents. The method includes the steps of collecting call associated information from a plurality of abandoned calls from clients, comparing the collected call associated information with a callback criteria and calling back those clients whose call associated information meets or exceeds the callback criteria.

### BRIEF DESCRIPTION OF THE DRAWINGS

FIG. 1 is a block diagram of an apparatus for rescuing abandoned calls in accordance with an illustrated embodiment of the invention.

### DETAILED DESCRIPTION OF AN ILLUSTRATED EMBODIMENT

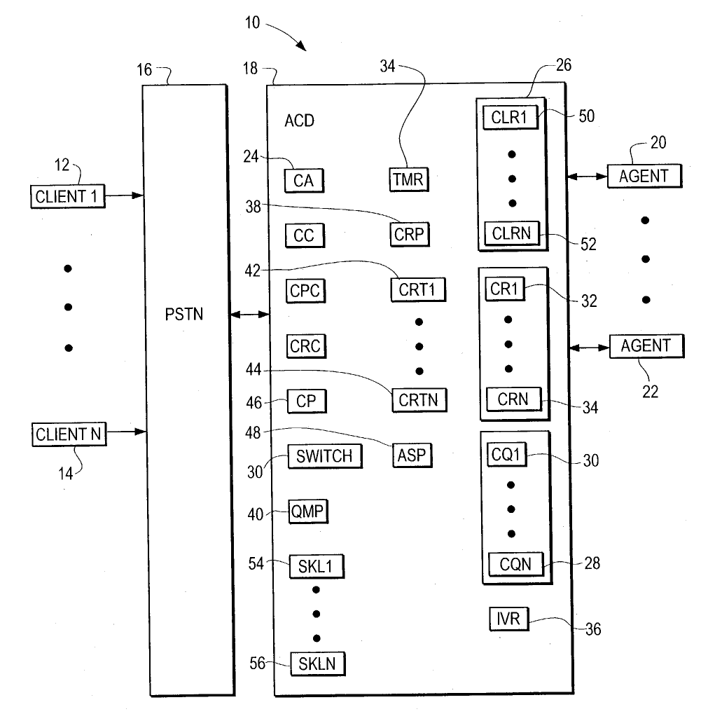

FIG. 1 depicts a call recovery system 10 for rescuing abandoned calls from high value clients shown in a context of use and in accordance with an illustrated embodiment of the invention. The system 10 may be used by any of a number of organizations (e.g., commercial, political, environmental) to route calls from clients to agents of the organization.

The system 10 of FIG. 1 may operate from within an automatic call distributor 18 as shown in FIG. 1 or as an adjunct to an ACD 18. Where operated as an adjunct to the ACD 18, the system 10 may simply receive information from and transfer telephone numbers and other information back to the ACD 18, as described below.

The organization may promulgate (e.g., by advertising or otherwise) a telephone number by which a client may contact the organization. Calls from clients 12, 14 may be connected to the ACD 18 through the public switched telephone network 16.

The ACD 18, in turn may function to connect incoming (and outgoing calls) to agents 12, 14. While only two agent stations 20, 22 are shown in FIG. 1, it should be understood that any number of agents 20, 22 may receive calls handled by the ACD 18. The agents 20, 22 of the ACD 18 may be divided into groups according to their skills in handling certain types of calls. Instead of directing calls to individual agents, the ACD 18 may route calls to groups of agents 20, 22. Where the agents 20, 22 are occupied, one or more call queues 28, 30 may be provided as a temporary destination for calls until an agent becomes available.

Each agent station 20, 22 may include a telephone console (not shown) and a terminal (also not shown). The console may be used by the agent to converse with the client 12, 14. The terminal may be used to display client records and to enter client information into a client database 26 within the ACD 18 or associated host.

Turning now to the ACD 18, as a whole, an explanation will be provided as to how call routing and handling is accomplished using the ACD 18. Based upon operation of the ACD 18, an explanation with also be provided as to how the system 10 may operate in conjunction with the ACD 18 to rescue abandoned calls by subsequently establishing call contact through the PSTN 16 between a client 12, 14 originating the subsequently abandoned call and an agent 20, 22.

As calls arrive from clients 12, 14 through the PSTN 16, they may be delivered along with call associated information (e.g., ANI, DNIS, etc.) from the PSTN 16. From DNIS information, a call analyzer 24 may determine a call destination of the call. This may be important in the case where the ACD 18 processes calls directed to a number of different telephone numbers, for example where the ACD 18 is used by a department store and the different telephone numbers identify different departments. ANI may also be used by the ACD 18 to facilitate call routings where the organization using the ACD 18 maintains a database 26 of client records.

In the case where the ACD 18 maintains a database 26 of client records, the call associated information (i.e., ANI) may be used to identify preexisting customers before the call is actually answered. By knowing the identity of a caller as well as the intended call destination (based upon DNIS), the ACD 18 may function to intelligently deliver each call to the most qualified agent 20, 22.

As calls arrive from clients 12, 14, the call analyzer 24 may open a call record 32, 34 for each call. The call record 32, 34 may be maintained within the ACD 18 for some predetermined time period (e.g., a day, a week, etc.) and then be deleted.

The call record 32, 24 may be used as a repository for call associated information that has been automatically collected by the call analyzer 24 and related call processors without the involvement of a human agent. For example, call associated information, such as ANI and DNIS would be added to the file immediately after the call record 32, 34 were opened. Other call associated information may also be collected based upon the handling and disposal of the call.

For example, if an agent is available and is connected to the call, an identifier of the agent that receives the call may be entered into the call record 32, 34. Alternatively, if an agent is not available, then the call may be placed in a call queue 28, 30. A queue monitoring processor 40 may monitor calls placed into the queue 28, 30. Upon placement of a call into a queue 28, 30, the queue monitoring processor 40 may activate a timer 34 to time the period of time that the call remains in the call queue 28, 30. The identifier of the call queue 28, 30 and length of time that the call remains in the call queue 28, 30 may also be entered into the call record 32, 34 by the call analyzer 24 or queue monitoring processor 40.

Alternatively, the call may be connected to an interactive voice response (IVR) unit 36. While connected to the IVR, the client 12, 14 may be presented with a number of options regarding the purpose of the call. The client 12, 14 may press a button on his touch-tone telephone or provide a voice response that may be decoded by the IVR 36. The responses provided through the IVR 36 may also be added to the call record 32, 34.

During the normal course of operation of the ACD 18, the ACD 18 may become overloaded when the arrival rate of calls from clients 12, 14 exceeds the number of agents 20, 22 available for processing those calls. When such an occurrence happens, the calls may be routed to the call queues 28, 30 until an agent becomes available. If the overload continues, clients 12, 14 may become discouraged and hang up. The queue monitoring processor 40 may detect abandonment by the client 12, 14 and add this information to the call record 32, 34.

In order to avoid the economic loss associated with abandoned calls, the call recovery system 10 may analyze the records 32, 34 of abandoned calls and may initiate telephone calls back to clients 12, 14 when the information contained within the call records 32, 34 meets a predetermined criterion or criteria. For example, where the call records 32, 34 contain duplicate entries from the same caller, then it may be assumed that this caller is highly motivated and, therefore, is a high value client.

In order to identify high value clients, a call records processor 38 may analyze calls abandoned by clients 12, 14 and may compare the contents of the records with a set of criteria 42, 44. In the example above, the criterion 42, 44 for call back may be a predetermined number of calls (i.e., duplicated call records 32, 34 from the same client) within a predetermined time period.

Once a call record(s) 32, 34 of a client 12, 14 is found to meet or exceed a criterion, the call records processor 38 may transfer the record 32, 34 to an agent selection processor 48 for selection of an agent 20, 22. Selection of an agent 20, 22 in advance of placing a call may be performed to ensure that a qualified agent is currently available to avoid adding to the frustration of the caller 12, 14.

Further, each criterion or criteria 42, 44 may have an associated skills list (file) 54, 56 that may correlated to the contents of the call record 32, 24. The skills file 54, 56 may function to define the skills needed by an agent to handle the call. For example, each criterion or criteria of the list of criteria 42, 44 may include a primary criterion for rescuing a call and a number of secondary criteria. The primary and secondary criteria may each have a skill set need by an agent to handle the call. If the primary criteria is met, but the secondary criteria are not met, then only the skill set associated with the primary criteria are imposed on agent selection.

An example of this situation may be provided by a merchant who provides a special telephone number for existing customers of some product. The primary criterion may be that the client 12, 14 calls some predetermined number of times (e.g., 2). A secondary criteria may be a subjective measurement related to the importance of the client.

The primary skill set may be familiarity with the product. A secondary skill set may be experience with the particular customer that called.

The agent selection processor 48 may select an agent 20, 22 based upon matching the skill set(s) with the content of the call record 32, 34 and any associated customer records 50, 52. For example, if the ANI of the caller cannot be matched with any existing client records, then agent selection may be based solely upon the called number (i.e., from DNIS information delivered along with the call), enhanced by skill set(s) associated with any selections made through the VRU 36. If the caller can be identified as an existing client based upon ANI information, then the agent selection processor 48 may select an agent based upon past transactions with the client 12, 14 and any other information collected during the current call session.

Once an agent 20, 22 has been selected, the ANI information may be transferred to a communication processor 46. The communication processor 46 may transfer the ANI information (i.e. the telephone number of the client 12, 14) to the PSTN 16 as a called number. Once the client 12, 14 answers the call, the communication processor 46 may connect the call between the client 12, 14 and selected agent 20, 22 using a switch 30.

The predetermined criteria 42, 44 may be based upon any of a number of factors, in addition to or as an alternative to the examples given above. For example, if the organization is a merchant, then a criteria for returning calls may be the identity of the client 12, 14 and the dollar value of business provided by the client 12, 14. Another criterion may be based upon a threshold value of time spent in a call queue 28, 30 or even the number dialed by the caller.

Other criterion may be negative in scope. For example, in anticipation of placing a call, the communication processor 46 may first check to be sure that the caller hasn't called again and is already present within a call queue 28, 30. If the caller is found within a call queue 28, 30, then instead of placing a call to the client 12, 14, the communication processor 46 may simply immediately connect the queued call to the selected agent 20, 22.

In general, it should be noted that the system 10 rescues calls by automatically collecting call associated information from an ACD 18 and initiating calls to clients based upon a criteria set by the organization operating the ACD 18. It is not a machine that initiates calls to clients based upon a request or some other affirmative act provided by the client and intended to initiate a return call to the client.

In another illustrated embodiment of the invention, calls to clients 12, 14 who have abandoned calls may be prioritized. Prioritization means ordering the criteria based upon a relative importance to the organization controlling the ACD 18 and returning calls with the greatest relative importance first.

Prioritization may be accomplished by associateding a series of weights to each primary and secondary criteria. While the weights associated with the primary criteria may be assumed to take priority in most cases, the opposite may be true in the case of important products and customers.

An adder may be used to sum the weights of each abandoned call that meets the criteria for callback. A comparator may be used to order the clients scheduled for callback. Callback may then be accomplished based upon relative status in the ordered list or a combination of relative status and agent availability.

A specific embodiment of a method and apparatus for rescuing abandoned calls according to the present invention has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention, any and all modifications, variations, or equivalents that fall within the true spirit and scope of the basic underlying principles disclosed and claimed herein.

1. A method of establishing contact with clients in a call center having a plurality of agents, such method comprising the steps of:
collecting call associated information for each of a plurality of calls to the call center that have been abandoned by clients;
comparing the collected call associated information with a callback criterion or criteria; and
calling back a clients whose call associated information meets or exceeds the callback criteria.

2. The method of contacting clients as in claim 1 wherein the step of calling back the client further comprises forming a skill requirement for the call.

3. The method of contacting clients as in claim 2 wherein the step of forming a skill requirement further comprises selecting an agent of the plurality of agents with a skill level that exceeds the skill requirement.

4. The method of contacting clients as in claim 3 wherein the step of selecting the agent further comprises connecting the selected agent with the client.

5. The method of contacting clients as in claim 4 wherein the step of connecting the agent further comprises searching a call queue for an already exising call from the client.

6. The method of contacting clients as in claim 1 wherein the step of searching the call queue further comprises transferring the call from the call queue to the selected agent.

7. The method of contacting clients as in claim 1 wherein the step of collecting call associated information further comprises collecting automatic number identifier information delivered along with the call from the client.

8. The method of contacting clients as in claim 1 wherein the step of collecting call associated information further comprises counting the abandoned calls from each client.

9. The method of contacting clients as in claim 1 wherein the step of collecting call associated information further comprises collecting information entered through an automatic voice response unit.

10. The method of contacting clients as in claim 1 further comprising identifying abandoned calls from existing clients.

11. The method of contacting clients as in claim 1 further comprising ordering call backs to clients based upon a relative importance of the call to an organization using the call center.

12. An apparatus for establishing contact with clients in a call center having a plurality of agents, such apparatus comprising: means for collecting call associated information from a plurality of abandoned calls from clients; means for comparing the collected call associated information with a callback criteria; and means for calling back those clients whose call associated information meets or exceeds the callback criteria.

13. The apparatus for contacting clients as in claim 12 wherein the means for calling back the clients further comprises means for forming a skill requirement for each call.

14. The apparatus for contacting clients as in claim 13 wherein the means for forming a skill requirement further comprises means for selecting an agent of the plurality of agents with a skill level that exceeds the skill requirement for each call.

15. The apparatus for contacting clients as in claim 14 wherein the means for selecting the agent further comprises means for connecting the selected agent with the client.

16. The apparatus for contacting clients as in claim 15 wherein the means for connecting the agent further comprises means for searching a call queue for a call from the client.

17. The apparatus for contacting clients as in claim 12 wherein the means for searching the call queue further comprises means for transferring the call from the call queue to the selected agent.

18. The apparatus for contacting clients as in claim 12 wherein the means for collecting call associated information further comprises means for collecting automatic number identifier information delivered along with the call from the client.

19. The apparatus for contacting clients as in claim 12 wherein the means for collecting call associated information further comprises means for counting the abandoned calls from each client.

20. The apparatus for contacting clients as in claim 12 wherein the means for collecting call associated information further comprises means for collecting information entered through an automatic voice response unit.

21. The apparatus for contacting clients as in claim 12 further comprising means for identifying abandoned calls from existing clients.

22. An apparatus for establishing contact with clients in a call center having a plurality of agents, such apparatus comprising: a call analyzer adapted to collect call associated information from a plurality of abandoned calls from clients; a call records processor adapted to compare the collected call associated information with a callback criterion; and a communication processor adapted to calling back those clients whose call associated information meets or exceeds the callback criteria.

23. The apparatus for contacting clients as in claim 22 further comprising an agent skills list associated with the call back criterion adapted to form a skill requirement for each call.

24. The apparatus for contacting clients as in claim 23 wherein the agent skill set further comprises an agent selection processor adapted to select an agent of the plurality of agents with a skill level that exceeds the skill requirement for each call.
